(19) United States
(12) Patent Application Publication
(10) Pub. No.: US 2018/0096513 A1
(43) Pub. Date: Apr. 5, 2018

(54) METHOD AND APPARATUS FOR DETERMINING NUMBER OF BITS ASSIGNED TO CHANNELS BASED ON VARIATIONS OF CHANNELS

(71) Applicant: Samsung Electronics Co., Ltd., Suwon-si (KR)

(72) Inventors: Jeong-ae PARK, Seoul (KR); Kwon-taek KWON, Hwaseong-si (KR)

(73) Assignee: Samsung Electronics Co., Ltd., Suwon-si (KR)

(21) Appl. No.: 15/609,555

(22) Filed: May 31, 2017

(30) Foreign Application Priority Data
Oct. 5, 2016 (KR) 10-2016-0128560

(51) Int. Cl. G06T 15/00; G06T 15/04; G09G 5/393

(52) U.S. Cl. CPC G06T 15/005; G06T 15/04; G09G 2340/02; G09G 2360/08; G09G 5/393

(57) ABSTRACT

A data processing method includes determining a variation of each of a plurality of channels corresponding to a plurality of pixels included in an image; determining a number of bits to assign to each of the plurality of channels based on the determined variation of each of the plurality of channels; assigning the determined numbers of bits to each of the plurality of channels; and compressing the plurality of channels based on the numbers of bits assigned to the plurality of channels, respectively.

### CROSS-REFERENCE TO RELATED APPLICATION

This application claims priority under 35 U.S.C. § 119 to Korean Patent Application No. 10-2016-0128560, filed on Oct. 05, 2016, in the Korean Intellectual Property Office, the disclosure of which is incorporated herein in its entirety by reference.

### BACKGROUND

### 1. Field

The present disclosure relates to methods and apparatuses for determining the number of bits assigned to channels based on variations of the channels.

### 2. Description of the Related Art

Device that display three-dimensional (3D) graphics on a screen can be used with a user interface (UI) applications and simulation applications.

As an image quality of 3D graphics increases, an amount of graphics data processed by devices that display the 3D graphics when rendering the 3D graphics may also increase. Further, a processing load, processing time and an amount of memory used may also increase as an image quality of the 3D graphics being rendered increases.

### SUMMARY

According to at least some example embodiments of the inventive concepts, a data processing method includes determining a variation of each of a plurality of channels corresponding to a plurality of pixels included in an image; determining a number of bits to assign to each of the plurality of channels based on the determined variation of each of the plurality of channels; assigning the determined numbers of bits to each of the plurality of channels; and compressing the plurality of channels based on the numbers of bits assigned to the plurality of channels, respectively.

According to at least some example embodiments of the inventive concepts, a data processing apparatus includes a processor configured to determine a variation of each of a plurality of channels corresponding to a plurality of pixels included in an image, determine a number of bits to assign to each of the plurality of channels based on the determined variation of each of the plurality of channels, assign the determined numbers of bits to each of the plurality of channels, and compress the plurality of channels based on the numbers of bits assigned to the plurality of channels, respectively.

According to at least some example embodiments of the inventive concepts, a method includes determining a variation of image data of a first channel of a first pixel, the first pixel being a pixel from among a plurality of pixels of an image, the first channel being a channel from among a plurality of channels corresponding, respectively, to a plurality of components of the pixel; assigning a first number of bits to the first channel based on the determined variation of the first channel; and storing bits of the image data of the first channel of the first pixel in a memory in accordance with the first number of bits assigned to the first channel.

### BRIEF DESCRIPTION OF THE DRAWINGS

The above and other features and advantages of example embodiments of the inventive concepts will become more apparent by describing in detail example embodiments of the inventive concepts with reference to the attached drawings. The accompanying drawings are intended to depict example embodiments of the inventive concepts and should not be interpreted to limit the intended scope of the claims. The accompanying drawings are not to be considered as drawn to scale unless explicitly noted.

FIG. 1 is a block diagram of an example of a graphics processing system according to at least one example embodiment of the inventive concepts;

FIG. 2 is a diagram of an example of a layout of an external memory or an on-chip memory according to at least one example embodiment of the inventive concepts;

FIG. 3 is a diagram for explaining an example of a compression/decompression apparatus according to at least one example embodiment of the inventive concepts;

FIG. 4 is a flowchart of an example of an operation of a compression/decompression apparatus according to at least one example embodiment of the inventive concepts;

FIG. 5 is a diagram for explaining an example in which a compression/decompression apparatus computes variations of channels according to at least one example embodiment of the inventive concepts;

FIG. 6 is a diagram for explaining an example in which a compression/decompression apparatus determines the number of bits assigned to channels according to at least one example embodiment of the inventive concepts;

FIG. 7 is a diagram for explaining an example in which a compression/decompression apparatus stores only upper bits among bits assigned to channels in a memory according to at least one example embodiment of the inventive concepts;

FIG. 8 is a diagram for explaining an example in which a compression/decompression apparatus stores a variation of a channel of a second pixel with respect to a value of a channel of a first pixel in a memory according to at least one example embodiment of the inventive concepts;

FIG. 9 is a flowchart of another example of an operation of a compression/decompression apparatus according to at least one example embodiment of the inventive concepts;

FIG. 10 is a diagram for explaining an example in which a compression/decompression apparatus computes variations of channels corresponding to a block according to at least one example embodiment of the inventive concepts; and

FIG. 11 is a block diagram of an example in which a compression/decompression apparatus is arranged outside a graphics processing unit (GPU) according to at least one example embodiment of the inventive concepts.

### DETAILED DESCRIPTION

As is traditional in the field of the inventive concepts, embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Further, each block, unit and/or module of the embodiments may be physically separated into two or more interacting and discrete blocks, units and/or modules without departing from the scope of the inventive concepts. Further, the blocks, units and/or modules of the embodiments may be physically combined into more complex blocks, units and/or modules without departing from the scope of the inventive concepts.

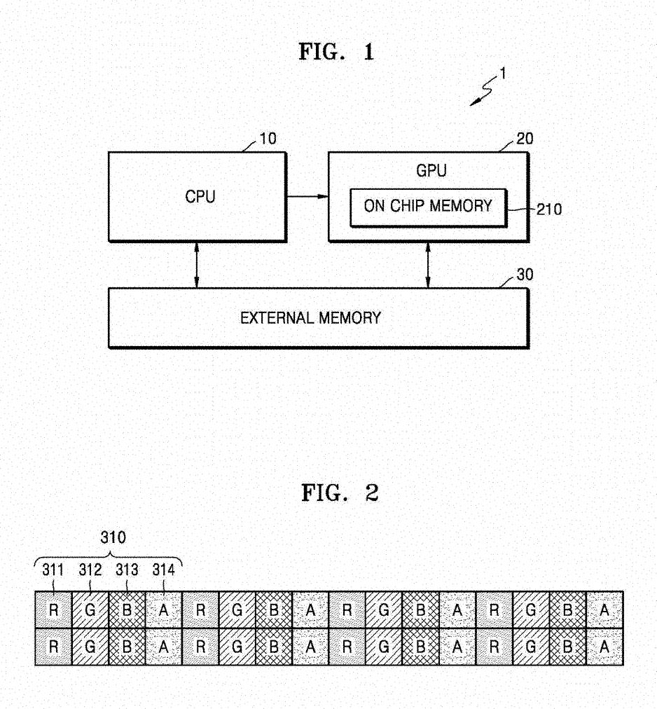

Further, FIG. 1 is a block diagram of an example of a graphics processing system 1 according to at least one example embodiment of the inventive concepts.

Referring to FIG. 1, the graphics processing system 1 may include a central processing unit (CPU) 10, a graphics processing unit (GPU) 20, and an external memory 30.

The CPU 10 may transmit data to the GPU 20. According to at least one example embodiment of the inventive concepts, the data transmitted by the CPU 10 to the GPU 20 may include, for example, shader codes and/or compiled shader codes. According to at least some example embodiments of the inventive concepts, a format of the shader codes transmitted by the CPU 10 is a format in which the shader codes can be executed by the GPU 20.

The GPU 20 may perform computation related to graphics by using the data transmitted from the CPU 10 and data stored in the external memory 30. For example, the GPU 20 may include a frame buffer and perform operations of a vertex shader, a rasterizer, a fragment shader, and a pixel shader. For example, the GPU 20 may execute program code that is stored in memory of the graphics processing system 1 and includes instructions for causing the GPU to perform the operations of a vertex shader, a rasterizer, a fragment shader, and/or a pixel shader.

According to at least one example embodiment of the inventive concepts, the GPU 20 may perform pixel shading by using the shader codes (or the compiled shader codes) transmitted from the CPU 10. According to at least one example embodiment of the inventive concepts, the GPU 20 may compute a color value of each of pixels included in a frame by using the shader codes (or the compiled shader codes). The term “frame” refers to an image that is to be displayed on a screen. A color may be set with respect to each of the pixels included in the frame, and thus, one image may be configured.

In another example embodiment, the GPU 20 may perform pixel shading by using texture images stored in the external memory 30. Texture images are image data used to determine colors of pixels included in a frame. According to at least one example embodiment of the inventive concepts, the GPU 20 may determine a color of each of a plurality of pixels by using the texture images stored in the external memory 30 without calculating the color value of each of the pixels included in the frame.

The external memory 30 may store information or data used for data processing by the CPU 10 and the GPU 20 and store results of the data processing by the CPU 10 and the GPU 20. According to at least one example embodiment of the inventive concepts, the external memory 30 may be embodied by random access memory (RAM). For example, the external memory 30 may be embodied by a dynamic random-access memory (DRAM). However, according to at least some example embodiments of the inventive concepts, the external memory 30 may also be embodied by other types of memory including, but not limited to, flash memory.

According to at least one example embodiment of the inventive concepts, the CPU 10 may store the shader codes (or the compiled shader codes) in the external memory 30, and the GPU 20 may operate by using the shader codes (or the compiled shader codes) stored in the external memory 30. The GPU 20 may store intermediate data generated while operating, and/or final data generated as a result of the operating, in the external memory 30. A texture image or a rendered image may be stored in the external memory 30 and, if it is determined (i.e., by the CPU 10 and/or GPU 20) that the texture image or the rendered image is frequently used by the GPU 20 or is scheduled to be used soon by the GPU 20, may be stored (i.e., by the CPU 10 and/or GPU 20) in an on-chip memory 210.

Data may be stored in the external memory 30 or the on-chip memory 210 in the form of one or more bits. Thus, the CPU 10 or the GPU 20 may compress data in accordance with a number of assigned bits and transmit the compressed data to the external memory 30 or the on-chip memory 210. Therefore, the texture image or the rendered image may also be expressed as one or more bits and stored in the external memory 30 or the on-chip memory 210. An example of a layout of the external memory 30 or the on-chip memory 210 will be described below with reference to FIG. 2. Example assignments of bits to various channels of an image are discussed in greater detail below with reference to FIG. 2.

FIG. 2 is a diagram of an example of a layout of the external memory 30 or the on-chip memory 210 according to at least one example embodiment of the inventive concepts.

Referring to FIG. 2, the external memory 30 or the on-chip memory 210 may store data corresponding to texture images or rendered images. A color space is a space concept expressing a three-dimensional (3D) color system. All colors of a color system may be expressed as 3D coordinates in the color space. For example, an RGB color space may express colors through an additive color mixture in which mixtures of colors increase brightness. The RGB color space may designate colors with respect to brightness of each of three channels (e.g., a red channel, a green channel, and a blue channel) corresponding, respectively, to three colors (e.g., red, green, and blue).

FIG. 2 illustrates an example of a layout of a single pixel 310 to which four channels 311, 312, 313, and 314 are assigned. Specifically, in the example shown in FIG. 2, the channels 311, 312, 313, and 314 are, respectively, red, green, blue, and transparency channels. The term “channel,” as used in the present disclosure, refers to a component of an image (e.g., a red component, a blue component, a green component, or a transparency component). A color space including the channels 311, 312, 313, and 314 is referred to as an RGBA color space. In the RGBA color space, transparency is expressed as alpha. Thus, a color of the pixel 310 is a combination of colors of the R channel 311, the G channel 312, the B channel 313, and the A channel 314.

Variations of the channels 311, 312, 313, and 314 may be different from each other according to an object appearing on an image. For example, if a variation degree of a color component of the pixel 310 is high and variation degrees of green, blue, and transparency image components are not high, a variation of the R channel 311 may be greater than variations of the G channel 312, the B channel 313, and the A channel 314. In this regard, when the same number of bits are assigned to the R channel 311, the G channel 312, the B channel 313, and the A channel 314, and the R channel 311, the G channel 312, the B channel 313, and the A channel 314 are compressed at the same compression ratio, information about the R channel 311 may be damaged (e.g., lost).

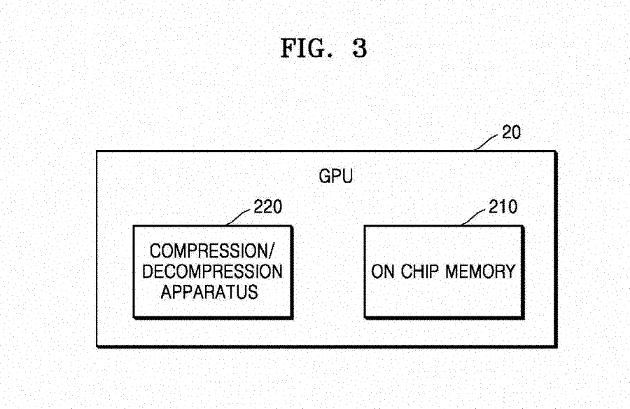

FIG. 3 is a diagram for explaining an example of a compression/decompression apparatus 220 according to at least one example embodiment of the inventive concepts.

Referring to FIG. 3, the compression/decompression apparatus 220 may be included in the GPU 20. For example, the compression/decompression apparatus 220 may correspond to one processor or a plurality of processors. A processor may be implemented as an array of a plurality of logic gates (e.g., an application-specific integrated circuit (ASIC) or a field-programmable gate array (FPGA)), or may be implemented as a combination of a microprocessor and a memory storing a program including computer-executable instructions that may be executed by the microprocessor. Further, those of ordinary skill in the art will understand that the processor may also be implemented as other types of hardware.

As described with reference to FIG. 2 above, when the same number of bits are assigned to all of a plurality of channels included in one pixel and the channels are compressed at the same compression ratio, information about a channel with a greatest variation may be damaged (e.g., lost). Further, an unnecessarily large amount of storage space may be assigned to the on-chip memory 210 or the external memory 30, and the GPU 20 may perform an unnecessarily large amount of computation.

The compression/decompression apparatus 220 according to at least one example embodiment of the inventive concepts may determine the number of bits assigned to each channel based on a variation of each channel. Further, the compression/decompression apparatus 220 may compress channels based on the determined number of bits and transmit the compressed channels to the on-chip memory 210 or the external memory 30, thereby preventing or, alternatively, reducing damage or loss of information about a channel with a great variation from being damaged or lost, reducing an amount of storage assigned to the on-chip memory 210 or the external memory 30, and reducing an amount of computation performed by the GPU 20.

The compression/decompression apparatus 220 is illustrated as an independent apparatus embedded in the GPU 20 in FIG. 3 but is not limited to the arrangement illustrated in FIG. 3. For example, the compression/decompression apparatus 220 may be located outside the GPU 20. As another example, the GPU 20 may perform the functions described in the present disclosure as being performed by the compression/decompression apparatus 220 by executing computer-executable program code that is stored in the graphics processing system 1 and includes instructions corresponding to the functions described in the present disclosure as being performed by the compression/decompression apparatus 220.

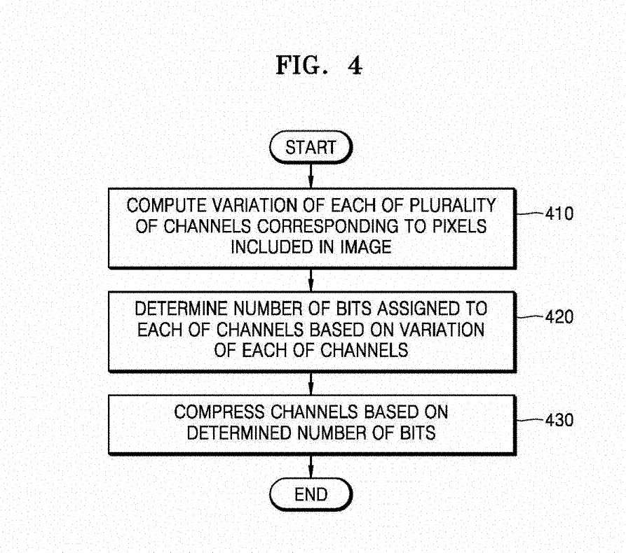

Examples of an operation of the compression/decompression apparatus 220 according to at least one example embodiment of the inventive concepts will be described in detail with reference to FIGS. 4 through 10 below.

FIG. 4 is a flowchart of an example of an operation of the compression/decompression apparatus 220 according to at least one example embodiment of the inventive concepts.

Referring to FIG. 4, a data processing method may include operations time-serially performed by the compression/decompression apparatus 220 of FIG. 3.

In operation 410, the compression/decompression apparatus 220 may compute a variation of each of a plurality of channels corresponding to pixels included in an image.

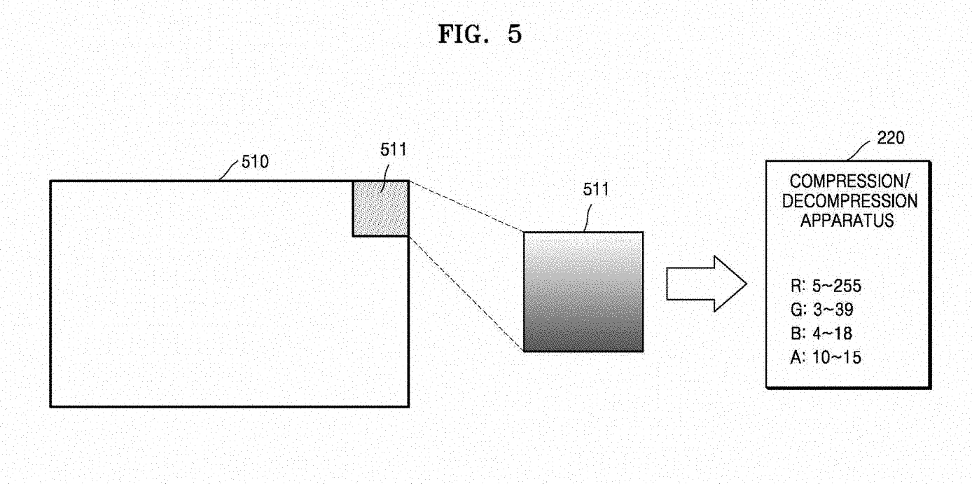

A frame corresponding to an image may include a plurality of pixels. A color of a single pixel may be determined according to values of a plurality of channels (for example, an R channel, a G channel, a B channel, and an A channel). The compression/decompression apparatus 220 may compute a variation of each of a plurality of channels corresponding to the single pixel. For example, the variation may be a natural number between 0 and about 255. An example in which the compression/decompression apparatus 220 computes variations of channels will be described with reference to FIG. 5 below.

FIG. 5 is a diagram for explaining an example in which the compression/decompression apparatus 220 computes variations of channels according to at least one example embodiment of the inventive concepts.

Referring to FIG. 5, a frame 510 may include a plurality of pixels 511 and may present one image when colors are set to the pixels 511. Meanwhile, colors of the pixels 511 may be expressed when channel values of channels corresponding to the pixels 511 vary and when the channel values do not vary. When the frame 510 corresponds to a texture image, the pixels 511 may be texels.

The compression/decompression apparatus 220 may compute variations of the channels corresponding to the pixel 511. For example, on the assumption that the pixel 511 includes an R channel, a G channel, a B channel, and an A channel, the compression/decompression apparatus 220 may compute a variation of the R channel as 250 (for example, from about 5 to about 255), a variation of the G channel as 36 (for example, from about 3 to about 39), a variation of the B channel as 14 (for example, from about 4 to about 18), and a variation of the A channel as 5 (for example, from about 10 to about 15).

Referring to FIG. 4, in operation 420, the compression/decompression apparatus 220 may determine the number of bits assigned to each of the channels based on the variations of the channels.

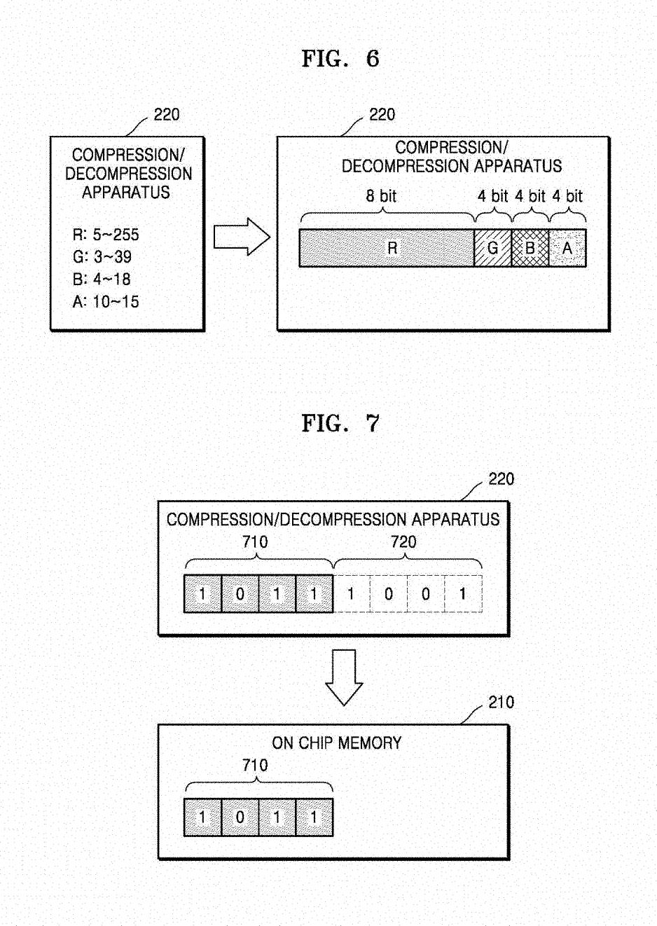

For example, the compression/decompression apparatus 220 may determine the number of bits such that the number of bits may be increased in proportion to the variations of the channels. In other words, the compression/decompression apparatus 220 may assign a greater number of bits to a channel with a greater variation. An example in which the compression/decompression apparatus 220 determines the number of bits assigned to channels will be described with reference to FIG. 6 below.

FIG. 6 is a diagram for explaining an example in which the compression/decompression apparatus 220 determines the number of bits assigned to channels according to at least one example embodiment of the inventive concepts.

A result of a variation of each channel computed by the compression/decompression apparatus 220 is illustrated in FIG. 6. For example, it is assumed that variations of an R channel, a G channel, a B channel, and an A channel are respectively computed as 250, 36, 14, and 5.

The compression/decompression apparatus 220 may determine the number of bits assigned to channels based on a variation of each of the channels. Referring to the example of FIG. 6, the variation of the R channel is the greatest. Thus, the compression/decompression apparatus 220 may determine the number of bits for each channel such that the number of bits assigned to the R channel may be more than the number of bits assigned to the G channel, the B channel, and the A channel. For example, the compression/decompression apparatus 220 may assign 8 bits to the R channel and 4 bits to each of the G channel, the B channel, and the A channel. For example, according to at least some example embodiments of the inventive concepts, the compression/decompression apparatus 220 may determine a number of bits to assign to a channel by increasing the number of bits determined to be assigned to the channel as the variation determined for the channel increases.

The compression/decompression apparatus 220 may determine the number of bits by reflecting the variation of each of the channels, and thus information about the R channel with the greatest variation may be stored in many bits compared to information about the G channel, the B channel, and the A channel. Thus, the same number of bits may be assigned to all channels, thereby preventing or, alternatively, reducing damage or loss of information about a channel (the R channel) with a greatest variation.

Referring to FIG. 4, in operation 430, the compression/decompression apparatus 220 may compress the channels based on the determined number of bits.

Further, although not shown in FIG. 4, the compression/decompression apparatus 220 may store compressed data in the on-chip memory 210 or the external memory 30.

As an example, the compression/decompression apparatus 220 may compress the channels by applying different compression ratios to the channels. For example, the compression/decompression apparatus 220 may compress data of a channel to which a relatively large number of bits are assigned with a relatively high compression ratio and compress data of a channel to which a relatively small number of bits are assigned with a relatively low compression ratio. To the contrary, the compression/decompression apparatus 220 may compress data of the channel to which a relatively large number of bits are assigned with a relatively low compression ratio and data of the channel to which a relatively small number of bits are assigned with a relatively high compression ratio.

As another example, the compression/decompression apparatus 220 may store only an upper n bits among bits assigned to the channels in the on-chip memory 210 or the external memory 30, where n is a positive integer. An example in which the compression/decompression apparatus 220 may store only upper n bits will be described with reference to FIG. 7 below. Thus, according to at least some example embodiments of the inventive concepts, only the n most significant are stored.

FIG. 7 is a diagram for explaining an example in which the compression/decompression apparatus 220 stores only upper bits 710 among bits assigned to channels in a memory according to at least one example embodiment of the inventive concepts.

An example in which the compression/decompression apparatus 220 assigns 8 bits 710 and 720 to store information about channels is illustrated in FIG. 7. The compression/decompression apparatus 220 may store only the upper bits (for example, upper 4 bits) 710 among the 8 bits 710 and 720 in the on-chip memory 210 or the external memory 30. In this case, the same effect as that that the compression/decompression apparatus 220 compresses all the 8 bits 710 and 720 may be obtained. According to at least some example embodiments of the inventive concepts, the compression/decompression apparatus 220 may store only n upper bits among m bits of a channel, wherein n and m are both positive integers, and m is greater than n. According to at least some example embodiments of the inventive concepts, the stored n bits are the n most significant bits of the channel.

In general, information relating to a color of a channel may be concentrated on the upper bits 710. For example, as shown in FIG. 7, with respect to an example in which the 8 bits 710 and 720 are assigned to the channels (i.e., 8 bits per channel), information relating to colors of the channels may be concentrated on the upper 4 bits 710 among the 8 bits 710 and 720. Thus, the compression/decompression apparatus 220 may store only the 4 bits 710 in the on-chip memory 210 or the external memory 30, and thus an effect similar to that of compressing all the 8 bits 710 and 720 may be obtained. Thus, according to at least some example embodiments of the inventive concepts, the compression/decompression apparatus 220 may perform compression by, for each channel among a plurality of channels, transmitting only n upper bits to a memory (e.g., the on-chip memory 210 or the external memory 30) among m bits of the channel.

If the compression/decompression apparatus 220 or the GPU 20 reads stored data, the compression/decompression apparatus 220 may read the stored upper 4 bits 710 and may fill in a default value (for example, “0000”) in the lower 4 bits 720.

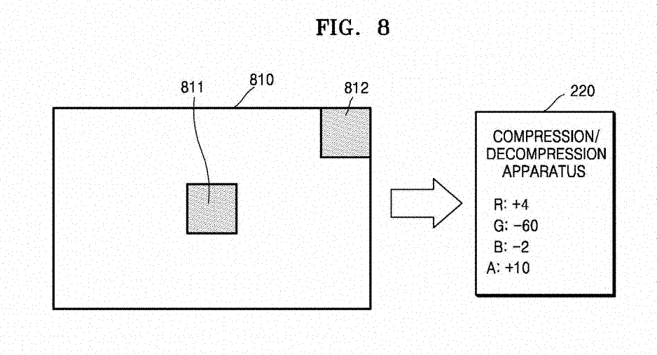

Referring to FIG. 4, as another example, the compression/decompression apparatus 220 may determine a first pixel among the pixels included in the frame as a reference pixel and may store a variation of a channel of a second pixel with respect to a value of a channel of the first pixel in the on-chip memory 210 or the external memory 30. An example in which the compression/decompression apparatus 220 stores a variation of a channel of a second pixel with respect to a value of a channel of a first pixel will now be described with reference to FIG. 8 below.

FIG. 8 is a diagram for explaining an example in which the compression/decompression apparatus 220 stores a variation of a channel of a second pixel 812 with respect to a value of a channel of a first pixel 811 in a memory according to at least one example embodiment of the inventive concepts.

The first pixel 811 and the second pixel 812 are illustrated in FIG. 8. When a frame 810 corresponds to a texture image, each of the first and second pixels 811 and 812 may be a texel.

The compression/decompression apparatus 220 may determine the first pixel 811 among pixels included in the frame 810 as a reference pixel. The first pixel 811 is illustrated as a pixel located in the center of the frame 810 in FIG. 8 but is not limited thereto.

The compression/decompression apparatus 220 may compute a value of each of channels of the first pixel 811. The compression/decompression apparatus 220 may compute a variation of a value of each of channels of the second pixel 812 with respect to the value of each of the channels of the first pixel 811. For example, the compression/decompression apparatus 220 may compute a variation of an R channel of the second pixel 812 with respect to a value of an R channel of the first pixel 811 as +4, a variation of a G channel of the second pixel 812 with respect to a value of a G channel of the first pixel 811 as −60, a variation of a B channel of the second pixel 812 with respect to a value of a B channel of the first pixel 811 as −2, and a variation of an A channel of the second pixel 812 with respect to a value of an A channel of the first pixel 811 as +10.

The compression/decompression apparatus 220 may also store the values of the channels of the first pixel 811 and the variations of the channels of the second pixel 812 in the on-chip memory 210 or the external memory 30. According to at least some example embodiments, the variations of the channels of the second pixel 812 relative to the channels of the first pixel 811 are stored in the on-chip memory 210 or the external memory 30 instead of storing the values of the channels of the second pixel 812. Thus, a storage space of the on-chip memory 210 or the external memory 30 may be efficiently utilized.

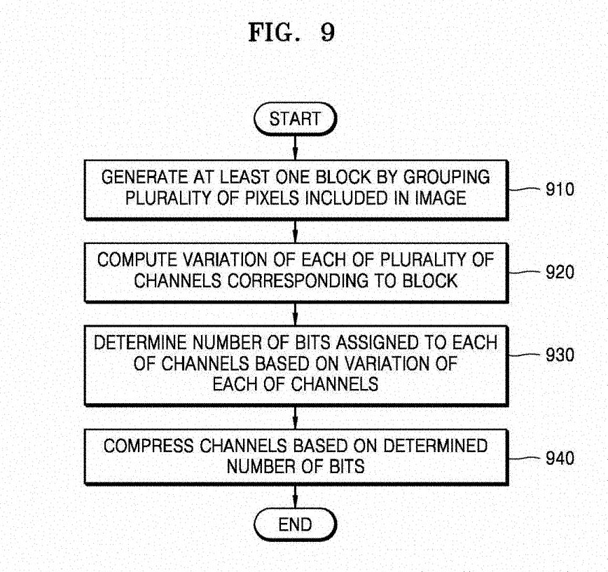

FIG. 9 is a flowchart of another example of an operation of the compression/decompression apparatus 220 according to at least one example embodiment of the inventive concepts.

Referring to FIG. 9, a data processing method may include operations time-serially performed by the compression/decompression apparatus 220 of FIG. 3.

Operations 930 and 940 of FIG. 9 are the same as operations 420 and 430 of FIG. 4. Thus, detailed descriptions of operations 930 and 940 will not be repeated below.

In operation 910, the compression/decompression apparatus 220 may generate at least one block by grouping pixels from among a plurality of pixels included in an image.

For example, the compression/decompression apparatus 220 may generate one block by designating a 4×4 arrangement of 16 pixels as the block. However, the arrangement of pixels included in a block is not limited to the 4×4 arrangement, and the number of pixels in a block is not limited to 16.

In operation 920, the compression/decompression apparatus 220 may compute a variation of each of a plurality of channels corresponding to the block.

If a region (for example, a background) in which a color does not greatly vary is present in the image, a computation of a channel value of each of pixels included in the region may be an unnecessary computation. Thus, the compression/decompression apparatus 220 may set adjacent pixels having a variation of a color below a desired or, alternatively, predetermined value as a block and may compute a variation of each of channels corresponding to the block.

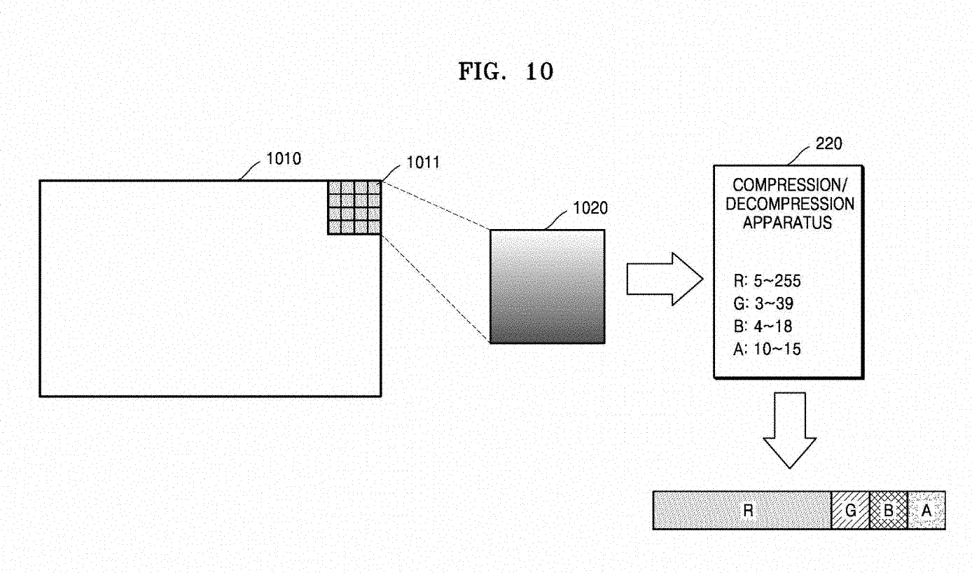

An example in which the compression/decompression apparatus 220 computes a variation of each of a plurality of channels corresponding to a block will now be described with reference to FIG. 10 below.

FIG. 10 is a diagram for explaining an example in which the compression/decompression apparatus 220 computes variations of channels corresponding to a block 1020 according to at least one example embodiment of the inventive concepts.

Referring to FIG. 10, a frame 1010 may include a plurality of pixels 1011 and may present one image when colors are set to the pixels 1011. When the frame 1010 corresponds to a texture image, the pixels 1011 may be texels.

The compression/decompression apparatus 220 may generate the block 1020 by grouping the pixels 1011. The block 1020 is illustrated to include the 16 pixels 1011 in FIG. 10 but is not limited thereto.

As described with reference to FIG. 9 above, colors of the pixels 1011 included in a region of an image such as a background may be similar. Thus, a variation of each of channels included in the pixel 1011 and a variation of each of channels of the block 1020 may be similar.

The compression/decompression apparatus 220 may compute variations of the channels corresponding to the block 1020. For example, when the block 1020 includes an R channel, a G channel, a B channel, and an A channel, the compression/decompression apparatus 220 may compute a variation of the R channel as 250 (for example, from about 5 to about 255), a variation of the G channel as 36 (for example, from about 3 to about 39), a variation of the B channel as 14 (for example, from about 4 to about 18), and a variation of the A channel as 5 (for example, from about 10 to about 15).

The compression/decompression apparatus 220 may determine the computed variation of each of the channels of the block 1020 as a variation of each of channels for each of pixels included in the block 1020. Further, the compression/decompression apparatus 220 may compute a variation of each of channels for the one pixel 1011 included in the block 1020 and may determine the computed variation as the variation of each of the channels for each of the pixels included in the block 1020. Thus, an amount of computation may be considerably reduced compared to a case where a variation of each of channels for each of all pixels included in the frame 1010 is computed.

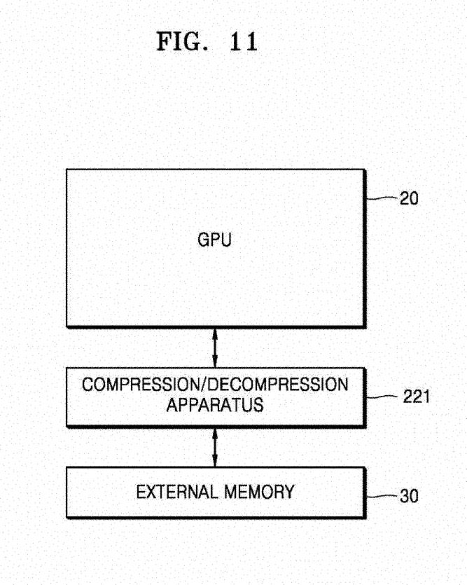

FIG. 11 is a block diagram of an example in which a compression/decompression apparatus 221 is arranged outside the GPU 20 according to at least one example embodiment of the inventive concepts.

Referring to FIG. 11, the compression/decompression apparatus 221 may be interposed between the GPU 20 and the external memory 30. As described with reference to FIG. 3, the compression/decompression apparatus 220 may be embedded in the GPU 20. However, as shown in FIG. 11, the compression/decompression apparatus 221 may be arranged outside the GPU 20 as an independent apparatus.

The compression/decompression apparatus 221 may assign an appropriate number of bits to data transmitted and received to and from the GPU 20 and the external memory 30, may compress the assigned bits, and may decompress the compressed bits, thereby preventing an unnecessary use of a storage space of the external memory 30. Further, an unnecessary computation of the GPU 20 or damage of information including data generated by the GPU may be prevented.

As described above, loss or damage of information about a channel with a great variation may be reduced or, alternatively, prevented, and an assignment of an unnecessary storage space to an on-chip memory or an external memory may be prevented. Further, an unnecessary computation of a GPU may be prevented.

At least some example embodiments of the inventive concepts can be embodied by a processor executing computer-executable code that is stored on a non-transitory computer-readable storage medium. Program code including computer-executable instructions for causing processor to perform operations according to at least some example embodiments may be stored on a non-transitory computer-readable storage medium, such as random access memory (RAM), read only memory (ROM), a permanent mass storage device (such as a disk drive), and/or any other like data storage mechanism capable of storing and recording data. Examples of non-transitory computer-readable storage media include, but are not limited to, flash memory, Blu-ray discs, DVDs, CDs, floppy disks, hard disk drives (HDDs), solid-state drives (SSDs), dynamic RAM (DRAM), synchronous DRAM (SDRAM), and static RAM (SRAM).

Example embodiments of the inventive concepts having thus been described, it will be obvious that the same may be varied in many ways. Such variations are not to be regarded as a departure from the intended spirit and scope of example embodiments of the inventive concepts, and all such modifications as would be obvious to one skilled in the art are intended to be included within the scope of the following claims.

What is claimed is:

1. A data processing method comprising:
determining a variation of each of a plurality of channels corresponding to a plurality of pixels included in an image;
determining a number of bits to assign to each of the plurality of channels based on the determined variation of each of the plurality of channels;
assigning the determined numbers of bits to the plurality of channels; and
compressing the plurality of channels based on the numbers of bits assigned to the plurality of channels, respectively.

2. The data processing method of claim 1, wherein the determining of a number of bits to assign comprises:
for each channel among the plurality of channels, increasing the number of bits determined to be assigned to the channel as the variation determined for the channel increases.

3. The data processing method of claim 1, further comprising:
generating at least one block by grouping pixels from among the plurality of pixels included in the image,
wherein the determining of a variation of each of a plurality of channels comprises:
determining a variation of each of a plurality of channels corresponding to the at least one block.

4. The data processing method of claim 1, wherein the compressing comprises:
for each channel among the plurality of channels, storing only n upper bits among m bits of the channel,
wherein n and m are both positive integers, and m is greater than n.

5. The data processing method of claim 1, further comprising:
storing data corresponding to the compressed plurality of channels.

6. The data processing method of claim 1, wherein the image includes a texture image or a rendered image.

7. The data processing method of claim 1, wherein the plurality of channels includes channels corresponding to each of red, green, blue, and transparency image components.

8. A non-transitory computer-readable storage medium storing a program for executing the data processing method of claim 1 on a computer.

9. A data processing apparatus comprising:
a processor configured to,
determine a variation of each of a plurality of channels corresponding to a plurality of pixels included in an image,
determine a number of bits to assign to each of the plurality of channels based on the determined variation of each of the plurality of channels,
assign the determined numbers of bits to the plurality of channels, and
compress the plurality of channels based on the numbers of bits assigned to the plurality of channels, respectively.

10. The data processing apparatus of claim 9, wherein the processor is configured to perform the determining of a number of bits to assign by, for each channel among the plurality of channels, increasing the number of bits determined to be assigned to the channel as the variation determined for the channel increases.

11. The data processing apparatus of claim 9 wherein,
the processor is further configured to generate at least one block by grouping pixels from among the plurality of pixels included in the image, and
the processor is configured to perform the determining of a variation of each of a plurality of channels by determining a variation of each of a plurality of channels corresponding to the at least one block.

12. The data processing apparatus of claim 9, wherein the processor is configured to perform the compressing by, for each channel among the plurality of channels, transmitting only n upper bits to a memory among m bits of the channel,
wherein n and m are both positive integers, and m is greater than n.

13. The data processing apparatus of claim 9, wherein the processor is configured to transmit data corresponding to the compressed plurality of channels to a memory.

14. The data processing apparatus of claim 9, wherein the image includes a texture image or a rendered image.

15. The data processing apparatus of claim 9, wherein the plurality of channels includes channels corresponding to each of red, green, blue, and transparency image components.

16. A method comprising:
determining a variation of image data of a first channel of a first pixel,
the first pixel being a pixel from among a plurality of pixels of an image,
the first channel being a channel from among a plurality of channels corresponding, respectively, to a plurality of components of the pixel;
assigning a first number of bits to the first channel based on the determined variation of the first channel; and
storing bits of the image data of the first channel of the first pixel in a memory in accordance with the first number of bits assigned to the first channel.

17. The method of claim 16 wherein the assigning includes determining the first number of bits based on the determined variation of the first channel.

18. The method of claim 17 wherein the determining of the first number of bits includes determining the first number of bits such that the determined first number of bits increases as the determined variation of the first channel increases.

19. The method of claim 17 wherein the storing includes storing only n bits among a plurality of bits of the image data of the first channel of the first pixel,
n being a positive integer corresponding to the assigned first number of bits.

20. The method of claim 19 wherein the stored n bits are n most significant bits among the plurality of bits of the image data of the first channel of the first pixel.
